(19) United States
(12) Patent Application Publication
(10) Pub. No.: US 2013/0286245 A1
(43) Pub. Date: Oct. 31, 2013

(54) SYSTEM AND METHOD FOR MINIMIZING FLICKER

(71) Applicant: Ramin Samadani, Palo Alto, CA (US)

(72) Inventor: Ramin Samadani, Palo Alto, CA (US)

(21) Appl. No.: 13/460,480

(22) Filed: Apr. 30, 2012

(51) Int. Cl. H04N 9/73; G06K 9/62

(52) U.S. Cl. 348/226.1; 382/165; 348/E09.051

(57) ABSTRACT

A method of reducing flicker in video is described. The method includes the steps of: determining an initial target frame color channel statistic value (Rₜ,Gₜ,Bₜ) based on at least the current video frame information; for each subsequent frame, determining a current frame color channel statistic value (R_{c},G_{c},B_{c}); for each subsequent video frame, updating the target frame color channel statistic value (Rₜ,Gₜ,Bₜ) based on at least the current video frame information, wherein the target value changes at a slower rate than the flicker frequency of the video frame; and for each color channel of each subsequent video frame, individually adjusting the current pixel values so that the current frame color channel static value (R_{c},G_{c},B_{c}) matches the target frame color channel statistic value (Rₜ,Gₜ,Bₜ).

### BACKGROUND

High frame rate cameras have been used in film. One aspect of film restoration is flicker reduction. Because flicker in old films can be random and spatially varying, different techniques may be used to minimize different aspects of flicker. One technique used to minimize flicker is compare the frames of histogram of the film frames and modify the film frame values to make the frames of the films being processed more similar. Another technique used to minimize flicker is temporal filtering. However, this approach can introduce artifacts and smearing. Successful flicker removal techniques can be semi-automatic or may need to be implemented manually since judgment may be required to differentiate between actual scene change and flicker.

### BRIEF DESCRIPTION OF DRAWINGS

The figures depict implementations/embodiments of the invention and not the invention itself. Some embodiments are described, by way of example, with respect to the following Figures.

FIG. 1 shows a flow diagram for a method of minimizing flicker in video according to an example of the invention;

FIG. 2A shows six consecutive frames of a video input sequence captured at high frame rate showing substantial flicker with changing color and brightness according to an example of the invention;

FIG. 2B shows the waveform associated with the fluorescent lighting that creates the variable output shown in FIG. 2A according to an example of the invention;

FIG. 2C show the six consecutive frames of the video input sequence captured in FIG. 2A after application of flicker reduction method according to an example of the invention;

FIG. 2D shows the graph associated with the fluorescent lighting that creates the variable output shown in FIG. 2B after application of the flicker reduction method according to an example of the invention;

FIG. 3 shows a system for minimizing flicker in a video according to an example of the invention;

FIG. 4 shows a computer system for implementing the method shown in FIG. 1 described in accordance with examples of the invention.

The drawings referred to in this Brief Description should not be understood as being drawn to scale unless specifically noted.

### DETAILED DESCRIPTION OF THE EMBODIMENTS

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. Also, different embodiments may be used together. In some instances, well known methods and structures have not been described in detail so as not to unnecessarily obscure the description of the embodiments.

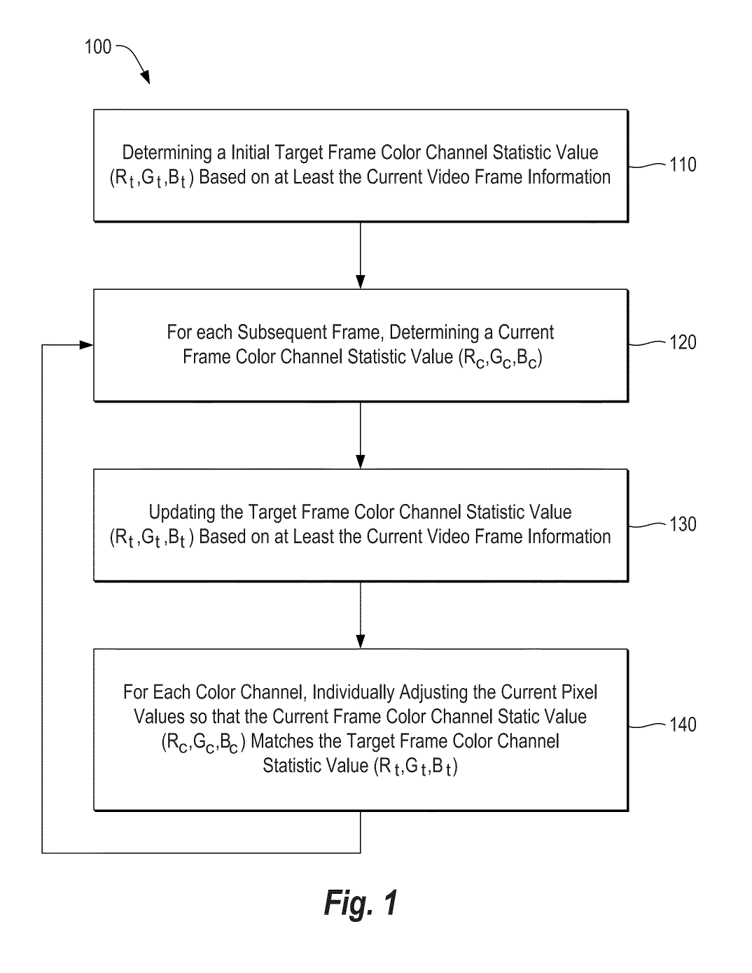

High frame rate capture can provide improved video quality by providing additional video information for use in motion estimation, segmentation, denoising, or other image processing methods. Unfortunately, ambient artificial light can cause substantial flicker in captured high rate video. This flicker, in turn decreases the effectiveness and sensitivity of image processing components such as block matching or difference thresholding, for example. An efficient, automatic method that substantially reduces flicker for image analysis is described. Referring to FIG. 1 shows a method 100 of reducing flicker includes the steps of: determining an initial target frame color channel statistic value (Rₜ,Gₜ,Bₜ) based on at least a current video frame information (step 110); for each subsequent video frame, determining a current frame color channel statistic value (R_{c},G_{c},B_{c}) (step 120); updating the target frame color channel statistic value (Rₜ,Gₜ,Bₜ) based on at least the current video frame information (step 130), wherein the target value changes at a slower rate than the flicker frequency of the video frame; and for each color channel of each subsequent video frame, individually adjusting the current pixel value so that the current frame color channel static value (R_{c},G_{c},B_{c}) matches the target frame color channel statistic value (Rₜ,Gₜ,Bₜ) (step 140).

The described method of minimizing flicker in video capture at high frame rates has the several advantages, including but not limited to: adapts to lighting variations, corrects for both brightness and color changes and low computational requirements. Further, the method when used as a pre-processing step provides a more stable, less time-variant output that is advantageous for improving performance of some image processing techniques such as block matching or image differencing.

High frame rate capture can be used to improve the quality of images output when used for example with low light capture, motion estimation, segmentation, denoising, etc. One reason for capturing video at high frame rates is that it can provide additional information for processing that can be an advantage for some image processing applications. For example, say that a gesture recognition application is utilized that recognizes hand movements. It might be extremely difficult to capture hand gestures accurately at a 30 fps frame rate, whereas capturing hand motions at the relatively high frame rate of 300 fps could be relatively easy. Thus at high frame rates it might be possible to confirm that a gesture had occurred—while confirming the gesture at a lower frame rate might be an impossibility. Although the lower frame rate vide© capture resulting in blurred hand motions might be acceptable for video output, it would not be acceptable for gesture recognition.

At low video frame capture, the time varying effects of the artificial fluorescent light are just averaged out—so that our eyes and the video camera capturing the video may not easily see/capture the changes in color and brightness. However, at high frame rates, the variations in brightness and color in time of the fluorescent lights can be seen. The major effect of the artificial illumination for our application is a global change of scene lighting due to the varying voltage applied to the lights.

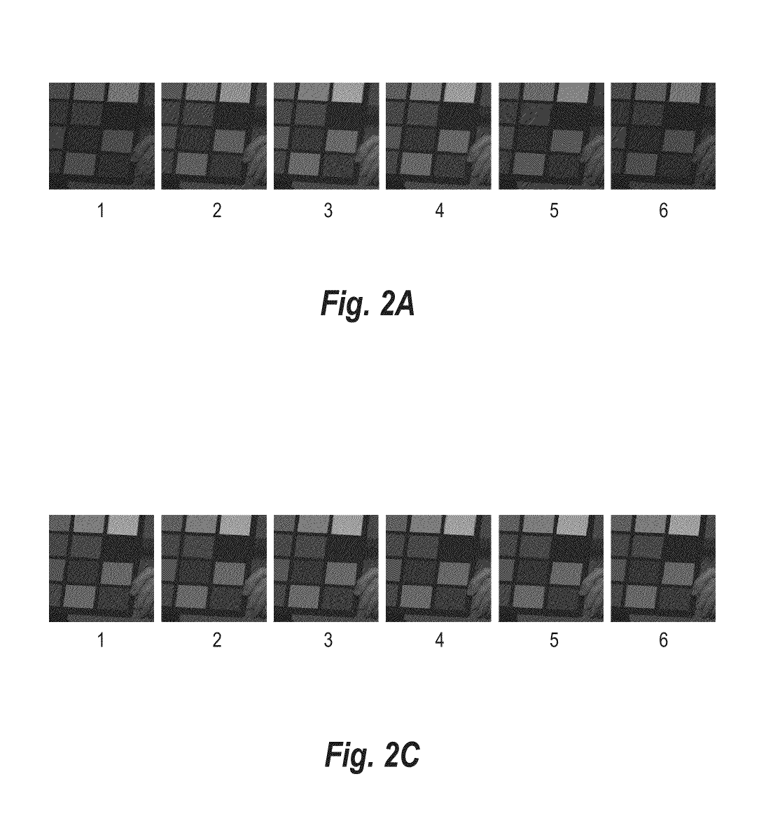

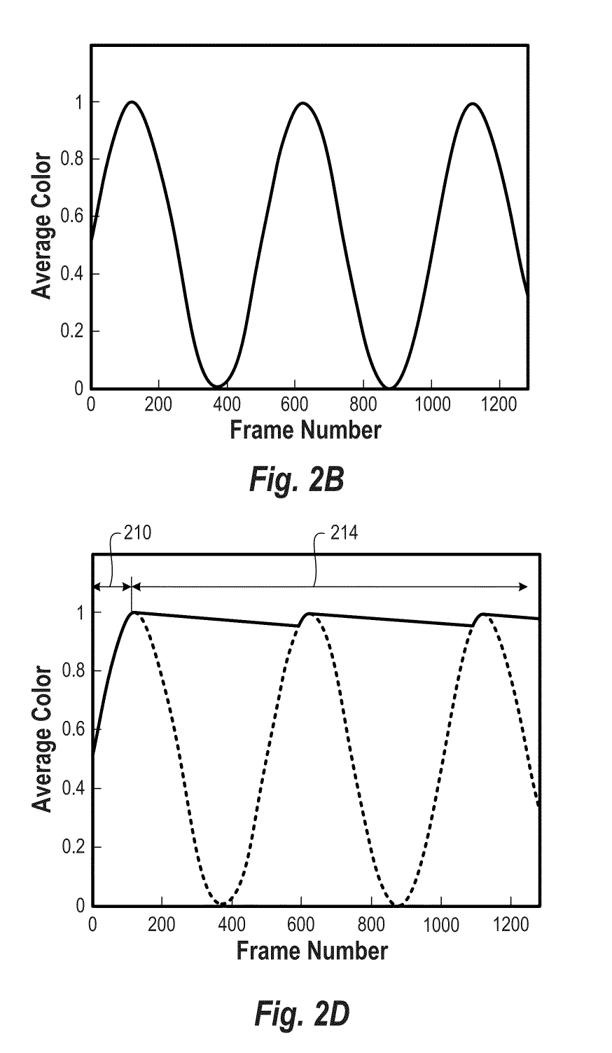

FIG. 2A shows six consecutive frames of a video sequence captured at a high frame rate (in this example 600 fps). The sequence shows substantial flicker with changing color and brightness. Referring to the color chart shown in the captured videos, the color square in the right uppermost corner should be white in each image. However, the right uppermost corner square which should be pure white—shifts in color. Referring to FIG. 2A, the “white” color square changes and first gets bluer and then yellower. These color changes occur because of the flicker associated with fluorescent lighting.

FIG. 2B shows the waveform associated with the fluorescent lighting that creates the variable output shown in FIG. 2A according to an example of the invention. The color and brightness variance corresponds to the variance in the waveform shown in FIG. 2B. For the example shown in FIG. 2A, the video was captured at 600 Hertz. The frame color and brightness of the sixth input frame is similar to the first input frame since the illumination changes occur at 120 Hertz (in the US).

When flicker is removed from old films—the final output is simply the original film modified to minimize flicker (the result after application of flicker removal techniques). For our purposes, instead of the final output being the output video modified to minimize flicker—it may be desirable to do additional image processing. At standard frame rates, time varying artificial lights (such as fluorescent lights) integrate well so that flicker is significantly less of a proble at high frame rates. At high frame rates, variations in color and brightness are captured that would not be captured at lower frame rates. Thus, flicker does not integrate as well at higher frame rates and can decrease the effectiveness and sensitivity of video processing techniques (i.e. block matching, difference thresholding) which use the output video. The described method provide an efficient technique that automatically reduces flicker to acceptable levels for subsequent video processing steps.

As previously stated one of the goals of the described method may be to provide an output where flicker is reduced as input for subsequent video processing. Computations associated with subsequent video processing may be improved by providing a more stable, less time variant output. Thus, one of the goals of the described method is to provide video output which minimizes the time variants due to the fluorescent lighting that is captured at high frame rates.

FIG. 2C show the six consecutive frames of the video input sequence captured at high frame rate in FIG. 2A after application of flicker reduction method according to an example. Compared to the video sequence shown in FIG. 2A, FIG. 2C shows a sequence which minimizes changes in color and brightness. Referring to the color chart shown in the captured videos shown in FIG. 2C, relative to the color in FIG. 2A the color square in the right uppermost corner appears to be white and does not change in color and brightness.

FIG. 2D shows the waveform associated with the fluorescent lighting that creates the variable output shown in FIG. 2B after application of the flicker removal method according to an example. Referring to FIG. 2D shows the output (represented by the solid line) after application of the flicker removal method superimposed on the waveform (the dotted line) shown in FIG. 2B. In comparison, after the initialization period where the waveforms are the same, the output shown in FIG. 2D produces a more stable, less time variant output.

Referring to FIG. 1 shows a flow diagram for a method of minimizing flicker in video captured at a high frame rate according to an example of the invention. A first step in this process is determining the initial target frame color channel statistic value (Rₜ,Gₜ,Bₜ) based on at least the current video frame information (step 110). Thus, for this example finding or determining the initial target frame color channel statistic value (Rₜ,Gₜ,Bₜ) (step 110) is accomplished by and includes the steps of: determining the initial color statistic value (Rᵢ,Gᵢ,Bᵢ); and for each color channel and for each color channel, setting the target frame color statistic value (Rₜ,Gₜ,Bₜ) to the initial color statistic value(Rᵢ,Gᵢ,Bᵢ).

The term color channel statistic value is used to describe a measureable color value quantity that varies as the light varies and that can be measured in the RGB color channel. The values can be quantities measured for a particular color channel(s) that are indicative of a color value (i.e. color, brightness, luminance).

Various types of color statistics may be used. In one example, the color statistic is the average color channel pixel value. In this case (for the initial frame) the average of each color channel of the first frame will be calculated. For the initial frame the values for each channel will be calculated and divided by the number of pixels. In another example, the color channel statistic value is the mean (the color statistic) of each color channel for the first frame. In another example, the median value may be used as the color statistic. The median value will also change as the color of the fluorescent light changes, however, the median value tends to be more less noisy. In another example, say if computational speed is a priority, instead of doing an average value of all of the pixels for a channel in the frame, alternatively an average value of a judicious sub-sampling of the pixels in the video frame may be used. In one example, the sampling could be a random sampling or alternatively a sampling on a grid of pre-determined points. Further, sequential estimation methods could be used to further improve the computational speed of the described method.

The step 110 is an initialization step. In one example, the initial frame is the first frame captured by the video camera. Thus, for this example, the initial target frame color channel statistic value is set to the initial color channel statistic value of the first frame. For the example, where the color statistic is the mean, we compute the mean (the color statistic) of each color channel for the first video frame.

The goal of the method is to reduce the flicker in the video—in this case the flicker or color changes in the fluorescent light. So the initialization value provides an initial value that can be used as a base value to compare against other subsequent values to see how it changes. The goal is to measure the color statistic value and see how the statistic varies in time. Measuring the color statistic value is way to determine the amount of flicker and how it is changing.

Referring to FIG. 1, an additional step in the method of minimizing flicker in video captured at a high frame rate is the step of determining the current frame color channel statistic value (R_{c},G_{c},B_{c}) (step 120). Once we know what the current frame color channel statistic value (R_{c},G_{c},B_{c}) is, we can updating the target frame color channel statistic value (Rₜ,Gₜ,Bₜ) based on at least the current video frame information, wherein the target value changes at a slower rate than the flicker frequency of the video frame (step 130).

As previously stated, a goal of the method is to produce output video frames that minimizes flicker. The described method does this by producing an output that minimizes the time-variant component of the ambient artificial light. It produces an output—that (after it reaches its steady state value) is relatively stable compared to the its captured input.

FIG. 2D shows a graph associated with the fluctuations in the ambient fluorescent lighting after application of the flicker removal algorithm according to an example. In one example, the described method uses a non-linear peak follower function to minimize flicker. Referring to the curve shown in FIG. 2D consists of an initialization phase or region 210—where the graph follows the curve of the sinusoidal pattern of the fluorescent light until the sinusoidal wave reaches its peak. After the initialization phase, there is a steady-state region 214 which maintains a relatively stable, relatively non-time variant output. The result of application of the method (in this example, a non-linear peak follower function) is a relatively stable output which results in less flicker being output in the video. FIG. 2C shows six consecutive frames of the video input sequence captured in FIG. 2A after application of flicker reduction method. Compared to the video captured in FIG. 2A, flicker (changes in color and brightness due to the variations in the ambient artificial light) is substantially reduced.

In the example shown in FIG. 2D, the method for minimizing flicker applies a peak follower non-linear function. In one example, the peak follower function can be described as comparing the current frame color channel statistic value of a color channel (in this case the green color channel) to the target frame color channel statistic value (in this case the green color channel) and if

If G_{c}>Gₜ then(Rₜ,Gₜ,Bₜ)=(R_{c},G_{c},B_{c}),

otherwise (Rₜ,Gₜ,Bₜ)=k*(Rₜ,Gₜ,Bₜ) (Eqn 1)

Referring to FIG. 20, the transient region of the graph shown in the left of the plot of FIG. 2D corresponds to the condition where G_{c}>Gₜ and the target frame color channel statistic value is set equal to the current frame color channel statistic value ((Rₜ,Gₜ,Bₜ)=(R_{c},G_{c},B_{c})). Further the steady state region of the graph shown in FIG. 20, corresponds to the condition where target Gₜ follows the peak of the flicker.

In summary, during the transient region of the graph shown in FIG. 2D, the peak follower function follows the sinusoidal wave pattern of the ambient artificial light shown in FIG. 2C by setting the color channel statistic of the target frame (shown graphically) equal to the current frame color channel statistic value. Thus the graph continues to go up until the peak value is reached. After the peak value is reached and G_{c} is less than Gₜ according to Eqn 1 then the target frame color channel statistic value is set equal to the target frame color channel statistic value multiplied by some constant k<1.

When the value of the fluorescent light (shown by sinusoidal wave pattern superimposed on FIG. 2D) goes down—the peak follower function remains high. This is the case where (G_{c}; is not greater than Gₜ according to Eqn. 1) then the peak remains at its previous high value of k*(Rₜ,Gₜ,Bₜ). So generally, the peak follower function provides an initial transient at the beginning of the application of the method (initialization region) and once it's past the transient—the output (the target value) basically follows the maximum or peak value multiplied by a constant k.

In one example, a peak follower decay value k of 0.999 results in the output shown in FIG. 2C. In the example, shown in FIG. 2D the droopiness of the k factor is exaggerated so that it easier to visualize the slow downward decay. The reason to have a peak follower that has some delay (k not equal to 1, for example) is to take into account change other than the flicker that is slowly varying. In one example, the slowly time-variant ambient light could be daylight coming into the scene so that the scene is gradually, slowly getting brighter. The constant k allows the function to follow a time variant light changes that occur slowly. The k constant will allow these slow time variant changes to be tracked and not averaged out by the relatively fast changes that occur due to the flicker of the artificial light.

This peak follower implicitly sets the target of the flicker reduction to be the brightest local frame in the periodic flicker sequence. In this way, the system can follow slow changes in lighting while automatically reducing the flicker, adjusting the frames to the brightest frames in the local time neighborhood. The known frequency of the flicker and the known capture frame rate help determine electricity is 50 Hz instead of 60 Hz (the frequency of electricity in the United States), in this case the value of k can be adapted to the frequency of the local region.

For the example given above, when comparing the current frame color channel statistic value to the target frame color channel statistic value, only a single color channel was compared—the green channel. In one example, green is chosen because the human eye is most responsive to green pixels compared to red and blue pixels. Further, green is most similar to luminance as the dominant component in luminance calculations. However, in another example—the red or blue color channel or alternatively a combination of color channels may be used in making the decision as to what data value to output. In one example, a single channel (the green color channel) was chosen for computational efficiency. In addition, choosing multiple color channels can increase the computational efficiency compared to choosing a single color channel where only a single decision (whether G_{c}>Gₜ) is made. Comparing multiple color channels to create multiple decisions may cause problematic color shifts because of potentially conflicting decisions for different color channels.

In one example, a non-linear function (peak follower) is used to implement the described method. However, other functions including linear target averaging functions may be used and other values, say an intermediate value, besides maximum or peak levels can be used for the target. The target is a function that takes input from the video frames captured at a high frame rate and produces an output that is steady and filters out the flicker caused by a time-variant artificial light source. The target is a function of the color statistic value extracted from a neighborhood of frames and should change slowly and be steady within the time frame of the flicker frequency. Further, the target needs to be able to change slowly as time goes on to be able to adapt to the slowly varying ambient light conditions due to natural light.

Referring to FIG. 1 shows the step of for each color channel of each subsequent vide© frame, individually adjusting the current pixel values so that the current frame color channel static value(R_{c},G_{c},B_{c}) matches the target frame color channel statistic value (Rₜ,Gₜ,Bₜ) (step 140). The goal of the method is to reduce flicker by providing a relatively stable output that minimizes light fluctuations due to artificial time-variant light sources. We do this by individually scaling each color channel after the average value (or other color statistic) is calculated. Specifically, we scale the current frame color statistic values to match the target frame color statistic values.

In one example, the goal of a stable output is achieved by scaling each color channel individually. For example, suppose the current frame color channel statistic values are R_{—c}=64, G_{c}=96, and B_{c}=128 and that the target frame color channel statistic values are Rₜ=192, Gₜ=180, and Bₜ=192. In this case, to scale the current pixel values to the target values, you multiply the current pixel values by the target frame color channel statistic values and divide by the current frame color channel statistic value. In this example, incoming pixels, R,G,B are multiplied by 192/64, 180/96, and 192/128 to provide the flicker reduced output R,G,B values. In the prior example, independent scaling of the channels was applied, but one can also use scaling that takes into account cross-terms between the different color channels by multiplying the input R,G,B pixel values with a scaling matrix to provide output flicker reduced R,G,B pixel values.

The described method is useful where there is an artificial light source (such as fluorescent lights) that is time variant with the frequency of electricity. However, for the case where there are no artificial light sources or for the case where the light of the artificial light source output is not strongly time variant (for example, incandescent lighting)—flicker is not a significant problem, even at high frame rates. Thus, it may be useful to determine whether flicker is occurring before the described method is applied. In one example, the method is adaptive in the sense that it can detect a certain amount of flicker and determine whether application of the described method is warranted. Alternatively a periodic flicker detector could be used at given intervals that automatically disables the described method when it is not needed.

Alternative variations to the describe method can be used. In one example, a simple diagonal matrix could be used for implementing the described method. Alternatively, the simple diagonal matrix could be replaced with a linear or affine approximation of R,G,B vectors across video frames. In one previously described example, the adjustment to the color channel was performed independently. In an alternative example, a more sophisticated matching that takes into account all the color channels together while performing color balancing. In one example, an improved fit could be accomplished using some off-diagonal elements also. In one example, the average values used for determining the color channel statistic values could be replaced with more robust statistics such as trimmed means, or iteratively weighted least square lines fits for individual color channels for two frames.

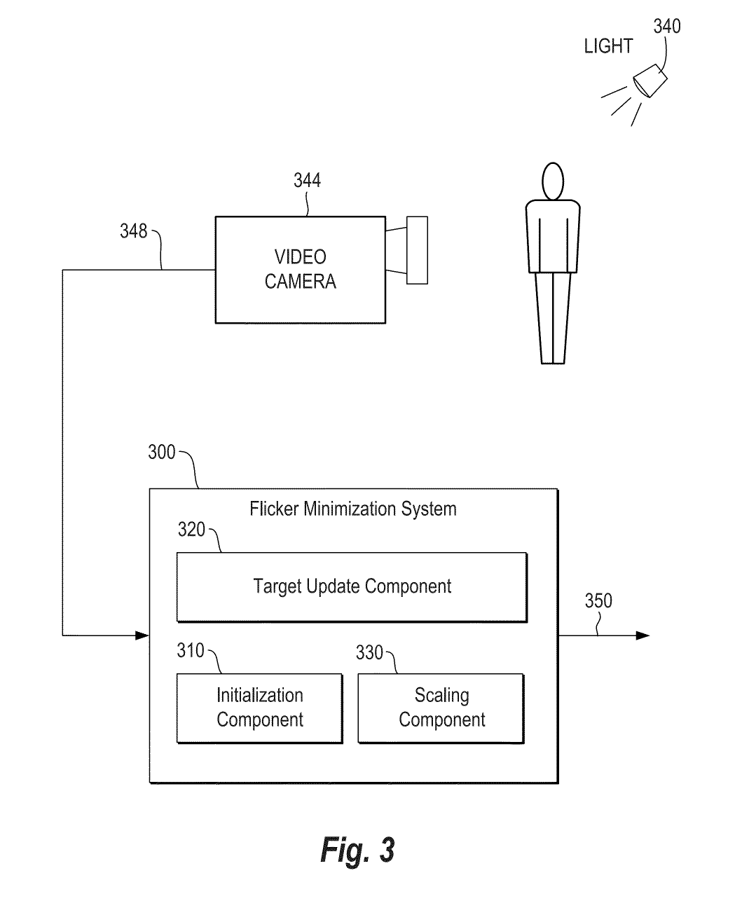

FIG. 3 shows a system 300 for minimizing flicker in video frames captured at a high frame rate according to an example of the invention. The flicker minimization system 300 shown in FIG. 3 is comprised of: an initialization component 310, a target update component 320, and a scaling component 330.

Video from a scene illuminated by fluorescent lighting 340 is captured by a video camera 344 at a high frame rate. The captured video 348 is input into the flicker minimization system 300. Because the video is captured by the high frame rate camera, the video capture would have color and brightness fluctuations similar to the video captured in FIG. 2A. In one example, the initialization component 310 determines the initial target frame color channel statistic value (Rₜ,Gₜ,Bₜ) based on at least the current video frame information. The initial target values are used in combination with the current frame color statistic values by the target update component 320 to update the target frame color channel statistic values. After the target value is updated, the scaling component 320 individually adjusts for each color channel the current pixel values so that the current frame color channel static value (R_{c},G_{c},B_{c}) matches the target frame color channel statistic value (Rₜ,Gₜ,Bₜ). After adjusting each color channel, the modified video frames are output 350. Relative to the input video 348, the modified video has a more stable, less transient output where flicker is reduced.

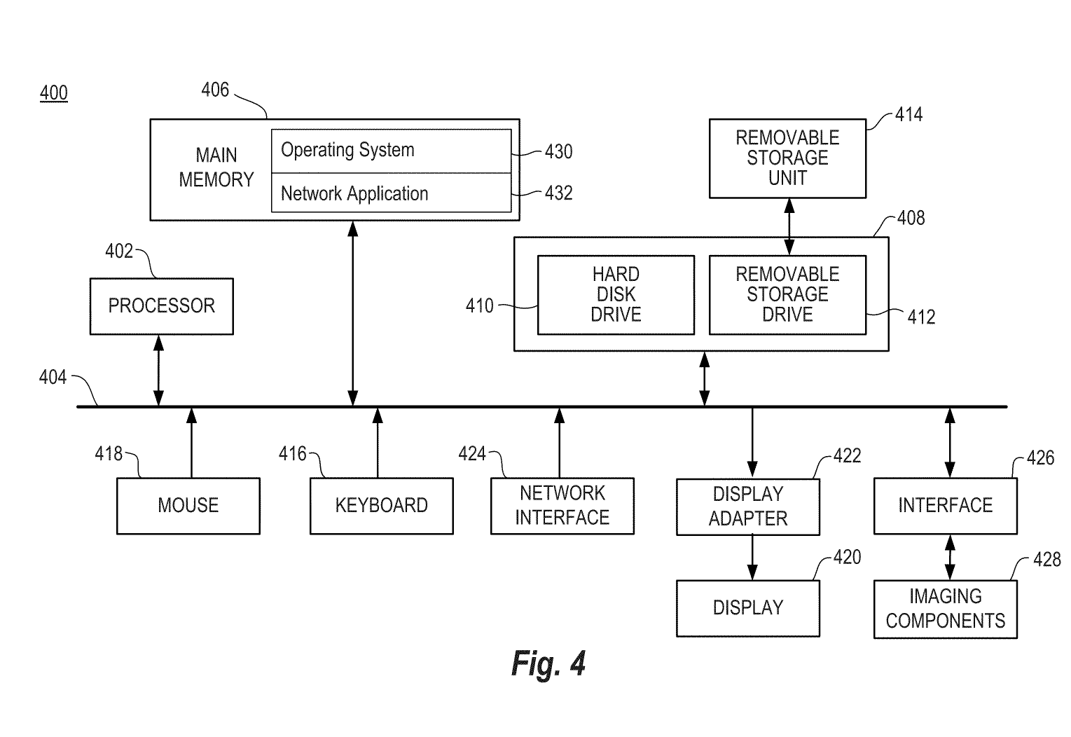

FIG. 4 shows a computer system for implementing the method shown in FIG. 1 described in accordance with examples of the present invention. The computing apparatus 400 includes one or more processor(s) 402 that may implement or execute some or all of the steps described in the method 100. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard drives 410 and/or a removable storage drive 412, representing a removable flash memory card, etc., where a copy of the program code for the method 100 may be stored. The removable storage drive 412 reads from and/or writes to a removable storage unit 414 in a weft-known manner.

These methods, functions and other steps described may be embodied as machine readable instructions stored on one or more computer readable mediums, which may be non-transitory. Exemplary non-transitory computer readable storage devices that may be used to implement the present invention include but are not limited to conventional computer system RAM, ROM, EPROM, EEPROM and magnetic or optical disks or tapes. Concrete examples of the foregoing include distribution of the programs on a CD ROM or via Internet download. In a sense, the Internet itself is a computer readable medium. The same is true of computer networks in general. It is therefore to be understood that any interfacing device and/or system capable of executing the functions of the above-described examples are encompassed by the present invention.

Although shown stored on main memory 406, any of the memory components described 406, 408, 414 may also store an operating system 430, such as Mac OS, MS Windows, Unix, or Linux; network applications 432; and a flicker minimization component 434. In one example, the flicker minimization component implements the method 100. The operating system 430 may be multi-participant, multiprocessing, multitasking, multithreading, real-time and the like. The operating system 430 may also perform basic tasks such as recognizing input from input devices, such as a keyboard or a keypad; sending output to the display 420; controlling peripheral devices, such as disk drives, printers, image capture device; and managing traffic on the one or more buses 404. The network applications 432 includes various components for establishing and maintaining network connections, such as software for implementing communication protocols including TCP/IP, HTTP, Ethernet, USB, and FireWire.

The computing apparatus 400 may also include an input devices 416, such as a keyboard, a keypad, functional keys, etc., a pointing device, such as a tracking ball, cursors, mouse 418, etc., and a display(s) 420. A display adaptor 422 may interface with the communication bus 404 and the display 420 and may receive display data from the processor 402 and convert the display data into display commands for the display 420.

The processor(s) 402 may communicate over a network, for instance, a cellular network, the Internet, LAN, etc., through one or more network interfaces 424 such as a Local Area Network LAN, a wireless 402.11×LAN, a 3G mobile WAN or a WiMax WAN. In addition, an interface 426 may be used to receive an image or sequence of images from imaging components 428, such as the image capture device.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. The method of reducing flicker includes the steps of:
determining an initial target frame color channel statistic value (Rₜ,Gₜ,Bₜ) based on at least the current video frame information;
for each subsequent frame, determining a current frame color channel statistic value (R_{c},G_{c},B_{c});
updating the target frame color channel statistic value (Rₜ,Gₜ,Bₜ) based on at least the current video frame information, wherein the target value changes at a slower rate than the flicker frequency of the video frame; and
for each color channel, individually adjusting the current pixel values so that the current frame color channel static value (R_{c},G_{c},B_{c}) matches the target frame color channel statistic values (Rₜ,Gₜ,Bₜ).

2. The method recited in claim 1 wherein the step of determining initial target frame color channel statistic value (Rₜ,Gₜ,Bₜ) includes the steps of: determining the initial color statistic value (Rᵢ,Gᵢ,Bᵢ); and for each color channel and for each color channel, setting the target frame color statistic value (Rₜ,Gₜ,Bₜ) to the initial color statistic value (Rᵢ,Gᵢ,Bᵢ).

3. The method recited in claim 1 wherein the step of updating the target frame color channel statistic value (Rₜ,Gₜ,Bₜ) includes the steps of: setting the target frame color statistic value (Rₜ,Gₜ,Bₜ) equal to the current frame color statistic value (R_{c},G_{c},B_{c}) when G_{c} is greater than Gₜ; and setting the target frame color statistic value (Rₜ,Gₜ,Bₜ) equal to the current frame color statistic value (R_{c},G_{c},B_{c}) multiplied by a peak follower constant k) when G_{c} is less than Gₜ.

4. The method recited in claim 1 wherein the color statistic is the mean of the RGB value.

5. The method recited in claim 1 wherein the color statistic is the median of the RGB value.

6. The method recited in claim 1 wherein the steps listed are steps applied before the application of other image processing techniques.

7. The method recited in claim 3 wherein the updating step is implemented using a peak follower function.

8. A non-transitory computer readable storage medium having computer readable program instructions stored thereon for causing a computer system to perform instructions, the instructions comprising the steps of:
determining an initial target frame color channel statistic value (Rₜ,Gₜ,Bₜ) based on at least the current video frame information;
for each subsequent frame, determining a current frame color channel statistic value (R_{c},G_{c},B_{c}),
updating the target frame color channel statistic value (Rₜ,Gₜ,Bₜ) based on at least the current video frame information, wherein the target value changes at a slower rate than the flicker frequency of the video frame; and
for each color channel, individually adjusting the current pixel values so that the current frame color channel static value (R_{c},G_{c},B_{c}) matches the target frame color channel statistic values (Rₜ,Gₜ,Bₜ).

9. The computer readable medium recited in claim 8 wherein the step of determining initial target frame color channel statistic value (Rₜ,Gₜ,Bₜ) includes the steps of: determining the initial color statistic value (Rᵢ,Gᵢ,Bᵢ); and for each color channel and for each color channel, setting the target frame color statistic value (Rₜ,Gₜ,Bₜ) to the initial color statistic value (Rᵢ,Gᵢ,Bᵢ).

10. The computer readable medium recited in claim 8 wherein the step of updating the target frame color channel statistic value (Rₜ,Gₜ,Bₜ) includes the steps of: setting the target frame color statistic value (Rₜ,Gₜ,Bₜ) equal to the current frame color statistic value (R_{c},G_{c},B_{c}) when G_{c} is greater than Gₜ; and setting the target frame color statistic value (Rₜ,Gₜ,Bₜ) equal to the current frame color statistic value (R_{c},G_{c},B_{c}) multiplied by a peak follower constant k) when G_{c} is less than Gₜ.

11. The computer readable medium recited in claim 8 wherein the color statistic is the mean of the RGB value.

12. The computer readable medium recited in claim 8 wherein the color statistic is the median of the RGB value.

13. The computer readable medium recited in claim 8 wherein the steps listed are steps applied before the application of other image processing techniques.

14. The computer readable medium recited in claim 10 wherein the updating step is implemented using a peak follower function.

15. A system for reducing flicker comprising:
an initialization component for determining an initial target frame color channel statistic value (Rₜ,Gₜ,Bₜ) based on at least the current video frame information;
a target update component for determining a current frame color channel statistic value (R_{c},G_{c},B_{c}) and for updating the target frame color channel statistic value (Rₜ,Gᵢ,Bₜ) based on at least the current video frame information, wherein the target value changes at a slower rate than the flicker frequency of the video frame; and
a scaling component, wherein for each color channel, individually adjusting the current pixel values so that the current frame color channel static value (R_{c},G_{c},B_{c}) matches the target frame color channel statistic values (Rₜ,Gₜ,Bₜ).

16. The system recited in claim 15 wherein the step of determining initial target frame color channel statistic value (Rₜ,Gₜ,Bₜ) includes the steps of: determining the initial color statistic value (Rᵢ,Gᵢ,Bᵢ); and for each color channel and for each color channel, setting the target frame color statistic value (Rₜ,Gₜ,Bₜ) to the initial color statistic value (Rᵢ,Gᵢ,Bᵢ).

17. The system recited in claim 15 wherein the step of updating the target frame color channel statistic value (Rₜ,Gₜ,Bₜ) includes the steps of: setting the target frame color statistic value (Rₜ,Gₜ,Bₜ) equal to the current frame color statistic value (R_{c},G_{c},B_{c}) when G_{c} is greater than Gₜ; and setting the target frame color statistic value (Rₜ,Gₜ,Bₜ) equal to the current frame color statistic value (R_{c},G_{c},B_{c}) multiplied by a peak follower constant k) when G_{c} is less than Gₜ.

18. The system recited in claim 15 wherein the color statistic is the mean of the RGB value.

19. The system recited in claim 15 wherein the color statistic is the median of the RGB value.

20. The method recited in claim 15 wherein the updating step is implemented using a peak follower function.
